(19) United States
(12) Patent Application Publication
(10) Pub. No.: US 2026/0154008 A1
(43) Pub. Date: Jun. 4, 2026

(54) REFRESH MANAGEMENT WITH LOCAL TEMPERATURE AWARENESS

(71) Applicant: Micron Technology, Inc., Boise, ID (US)

(72) Inventors: Lingming Yang, Meridian, ID (US); Raghukiran Sreeramaneni, Frisco, TX (US)

(21) Appl. No.: 19/348,441

(22) Filed: Oct. 2, 2025

Related U.S. Application Data
(60) Provisional application No. 63/727,038, filed on Dec. 2, 2024.

(51) Int. Cl. G06F 3/06

(52) U.S. Cl. CPC G06F 3/0659; G06F 3/0604; G06F 3/0673

(57) ABSTRACT

A high-bandwidth memory (HBM) device with localized refresh adjustment is disclosed. The HBM device contains one or more volatile memory dies, each with memory arrays and associated temperature sensors which characterize the temperature of the memory arrays. A refresh management circuit of the HBM device receives refresh commands directed to a certain memory array, determines the temperature of the array, and performs one or more refresh operations based on the temperature of the memory array or a portion thereof. The refresh commands may come from a host device coupled to the HBM device and/or be generated by the HBM device.

### CROSS-REFERENCE TO RELATED APPLICATION(S)

The present application claims priority to U.S. Provisional Application No. 63/727,038, filed Dec. 2, 2024, the disclosure of which is incorporated herein by reference in its entirety.

### TECHNICAL FIELD

The present technology is generally related to vertically stacked semiconductor memory devices and, more specifically, to systems and methods for performing refresh operations on a high-bandwidth memory device of a system-in-package.

### BACKGROUND

An electronic apparatus (e.g., a processor, a memory device, a memory system, or a combination thereof) can include one or more semiconductor circuits configured to store and/or process information. For example, the apparatus can include a memory device, such as a volatile memory device, a non-volatile memory device, or a combination device. Memory devices, such as dynamic random-access memory (DRAM) and/or high-bandwidth memory (HBM), can utilize electrical energy to store and access data.

With technological advancements in embedded systems and increasing applications, the market is continuously looking for faster, more efficient, and smaller devices. To meet market demands, semiconductor devices are being pushed to the limit with various improvements. Improving devices, generally, may include increasing circuit density, increasing circuit capacity, increasing operating speeds (or otherwise reducing operational latency), increasing reliability, increasing data retention, reducing power consumption, or reducing manufacturing costs, among other metrics. Attempts, however, to meet market demands, such as by reducing the overall device footprint, can often introduce challenges in other aspects, such as maintaining circuit robustness and/or failure detectability.

### BRIEF DESCRIPTION OF THE DRAWINGS

FIG. 1 illustrates a partially schematic cross-sectional diagram of a system-in-package device.

FIG. 2 illustrates a partially schematic cross-sectional diagram of a system-in-package device configured in accordance with some embodiments of the present technology.

FIG. 3 illustrates a simplified block diagram schematically illustrating a refresh management circuit configured in accordance with some embodiments of the present technology.

FIG. 4 illustrates a flow diagram of a process for performing a refresh command on a high-bandwidth memory device configured in accordance with some embodiments of the present technology.

FIG. 5 illustrates a flow diagram of a process for performing a refresh command on a high-bandwidth memory device configured in accordance with some further embodiments of the present technology.

The drawings have not necessarily been drawn to scale. Similarly, some components and/or operations can be separated into different blocks or combined into a single block for the purpose of discussion of some of the implementations of the present technology. Moreover, while the technology is amenable to various modifications and alternative forms, specific implementations have been shown by way of example in the drawings and are described in detail below. The intention, however, is not to limit the technology to the particular implementations described.

### DETAILED DESCRIPTION

High data reliability, high speed of memory access, lower power consumption, and reduced chip size are features that are demanded from semiconductor memory. In recent years, vertically stacked memory devices have been introduced, often referred to as 2.5-dimensional (“2.5D”) memory devices when placed adjacent to a host device or 3-dimensional (“3D”) memory devices when stacked on top of the host device. Some 2.5D or 3D memory devices are formed by stacking memory dies vertically, and interconnecting the dies using through-silicon (or through-substrate) vias (TSVs). Benefits of the 2.5D and 3D memory devices include shorter interconnects (which reduce circuit delays and power consumption), a large number of vertical vias between layers (which allow wide bandwidth buses between functional blocks, such as memory dies, in different layers), and a considerably smaller footprint. Thus, the 2.5D and 3D memory devices contribute to higher memory access speed, lower power consumption, and chip size reduction. Example 2.5D and/or 3D memory devices include Hybrid Memory Cube (HMC) and High-Bandwidth Memory (HBM) devices. For example, HBM devices are a type of memory that includes a vertical stack of dynamic random-access memory (DRAM) dies and an interface die (which, e.g., provides the interface between the DRAM dies of the HBM device and a host device).

In a system-in-package (SiP) configuration, HBM devices may be integrated with a host device (e.g., a graphics processing unit (GPU), a computer processing unit (CPU), a tensor processing unit (TCU), and/or any other suitable processing unit) using a base substrate (e.g., a silicon interposer, a substrate of organic material, a substrate of inorganic material and/or any other suitable material that provides interconnection between the host device and the HBM device and/or provides mechanical support for the components of a SiP device), through which the HBM devices and host communicate. Because traffic between the HBM devices and host device resides within the SiP (e.g., using signals routed through the silicon interposer), a higher bandwidth may be achieved between the HBM devices and host device than in conventional systems. In other words, the TSVs interconnecting DRAM dies within an HBM device, and the silicon interposer integrating HBM devices and a host device, enable the routing of a greater number of signals (e.g., wider data buses) than is typically found between packaged memory devices and a host device (e.g., through a printed circuit board (PCB)). The high-bandwidth interface within a SiP enables large amounts of data to move quickly between the host device (e.g., GPU/CPU/TCU) and HBM devices during operation. For example, the high-bandwidth channels can be on the order of 1000 gigabytes per second (GB/s, sometimes also referred to as gigabits (Gb)). As a result, the SiP device can quickly complete computing operations once data is loaded into the HBM devices. SiP devices, in turn, are typically integrated with a package substrate (e.g., a PCB) adjacent to other electronics and/or other SiP devices within a packaged system.

Market demands on SiP devices and/or the HBM devices therein can present certain challenges, however. One such challenge is that SiP devices (and the HBM devices therein) are increasing in functionality and/or speed, while package size is decreased or maintained, thereby increasing the power density within the SiP device. As a result, and as discussed in more detail below, traffic-heavy circuits in HBM devices, such as input/output (“IO”) circuits in an interface die, can generate significant amounts of heat. As described herein, the heat generated by traffic-heavy circuits in HBM devices, such as by the IO circuits, and hot spots localized to those traffic-heavy circuits, can cause deleterious effects on the HBM device.

For example, the DRAM dies of an HBM device are made up of one or more DRAM memory arrays, each of which contains a plurality of memory cells. Each memory cell (representing a single bit of data) is typically implemented with a capacitor, where the capacitor's charge indicates the bit's value (e.g., a charged capacitor may indicate a logical value of ‘1’ in the memory cell, and a discharged capacitor may indicate a logical value of ‘0’ in the memory cell). Over time each capacitor's charge naturally leaks (e.g., a charged capacitor slowly discharges to a discharged state), which can result in data loss. Therefore DRAM-based memories, such as HBM devices, periodically read contents from the DRAM and write the data back to the DRAM, thereby restoring the charge in the corresponding capacitor. This operation is known as a refresh. A host device (and/or memory controller therein) may periodically issue a refresh command that triggers a refresh operation (e.g., a read and write back) of one or more arrays of DRAM.

It has been observed that capacitors in memory cells discharge more quickly when at higher temperature, and therefore need to be refreshed more frequently in order to maintain memory integrity. Some approaches to account for temperature when performing refresh operations are known, but suffer from various shortcomings. For example, as described below, some approaches rely on a single temperature value associated with an HBM device, based on which the refresh rate is set uniformly for the entire HBM device. These approaches, however, fail to account for the fact that temperatures are uneven within an HBM device (e.g., temperatures are highest at hot spots generated by high-traffic circuits), and therefore not all memory cells need to be refreshed at the same rate.

The systems and methods described herein address the above-described and other shortcomings by adjusting the rate of refresh operations performed at a location based on the temperature associated with that location. As described herein, HBM devices with localized refresh adjustment modify the rate of refresh operations performed on different regions of memory (e.g., each memory array, memory bank, etc.) independently based on the temperature of the associated memory region. For example, when an HBM device with localized refresh adjustment (also referred to herein as a local-temperature-aware HBM device) receives a refresh command from a host device directed to a particular memory region, the HBM device can determine a refresh rate based on the temperature of the memory array associated with the memory region, and perform one or more refresh operations on the memory array based on the temperature. Further, the HBM device with localized refresh adjustment can generate different number of refresh operations for different memory regions depending on the temperature at the memory region (e.g., a host-initiated refresh command to a first memory region may generate one refresh operation, and a host-initiated refresh command to a second memory region may generate two refresh operations, if the second memory region is hotter than the first memory region). In other words, the host device can issue refresh commands at a default rate, and the HBM device with localized refresh adjustment will perform refresh operations on the memory arrays at different rates that are appropriate for their different temperatures.

As used herein, the terms “vertical,” “lateral,” “upper,” “lower,” “top,” and “bottom” can refer to relative directions or positions of features in the devices in view of the orientation shown in the drawings. For example, “bottom” can refer to a feature positioned closer to the bottom of a page than another feature. These terms, however, should be construed broadly to include devices having other orientations, such as inverted or inclined orientations where top/bottom, over/under, above/below, up/down, and left/right can be interchanged depending on the orientation.

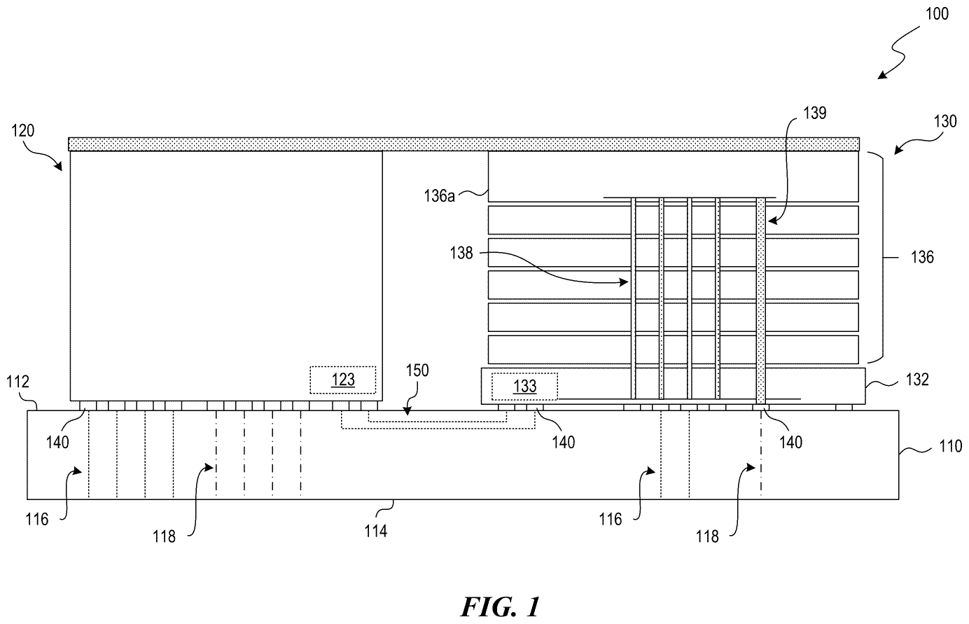

FIG. 1 is a partially schematic cross-sectional diagram of a SiP device 100. As illustrated in FIG. 1, the SiP device 100 includes a base substrate 110 (e.g., a silicon interposer, another organic interposer, an inorganic interposer, and/or any other suitable base substrate), as well as a host device 120 and an HBM device 130 each integrated with (e.g., carried by and coupled to) an upper surface 112 of the base substrate 110 through a plurality of interconnect structures 140 (three labeled in FIG. 1). The interconnect structures 140 can be solder structures (e.g., solder balls), metal-metal bonds, and/or any other suitable conductive structure that mechanically and electrically couples the base substrate 110 to each of the host device 120 and the HBM device 130. Further, the host device 120 is coupled to the HBM device 130 through one or more communication channels 150 formed in the base substrate 110 (sometimes referred to as a SiP bus). The communication channels 150 can include one or more route lines (two illustrated schematically in FIG. 1) formed into (or on) the base substrate 110.

As further illustrated in FIG. 1, the base substrate 110 includes a plurality of external signal TSVs 116 and a plurality of external power TSVs 118 extending between the upper surface 112 and a lower surface 114 of the base substrate 110. The external signal TSVs 116 can communicate signals (e.g., data, control signals, processing commands, and/or the like) between the host device 120 and/or the HBM device 130 and an external component (e.g., a PCB the base substrate 110 is integrated with, an external controller, and/or the like). The external power TSVs 118 provide electrical power to the host device 120 and/or the HBM device 130 from an external power source.

The host device 120 can include a variety of components, such as a processing unit (e.g., CPU/GPU/TCU), one or more registers, one or more cache memories, and/or a variety of other components. For example, in the illustrated environment, the host device 120 includes a host IO circuit 123 that can direct signals to and/or from the HBM device 130 through the communication channels 150. Additionally, or alternatively, the host IO circuit 123 can direct signals to and/or from an external component (e.g., a controller coupled to one or more of the external signal TSVs 116 and/or the like).

The HBM device 130 can include an interface die 132 and a stack of one or more memory dies 136 (six illustrated in FIG. 1) carried by the interface die 132. The HBM device 130 also includes one or more signal TSVs 138 (four illustrated in FIG. 1) and one or more power TSVs 139 (one illustrated in FIG. 1) each extending from the interface die 132 to an uppermost memory die 136a. The power TSV(s) 139 provide power (e.g., received from one or more of the external power TSVs 118) to the interface die 132 and each of the memory dies 136. The signal TSVs 138 communicably couple each of the memory dies 136 to an IO circuit 133 in the interface die 132 (in addition to various other circuits in the interface die 132). In turn, the IO circuit 133 can direct signals to and/or from the host device 120 and/or an external component (e.g., an external storage device coupled to one or more of the external signal TSVs 116).

Each of the memory dies 136 may be a DRAM memory die. DRAM dies are typically organized into one or more memory arrays, each containing a plurality of memory cells (not shown in the schematic cross section of FIG. 1), where each memory cell represents a single logical bit of memory. These logical bits may be grouped into logical memory regions, each associated with a memory array, a bank, a bank group, etc. Although the use of DRAM memory for memory dies 136 can provide fast speeds, this approach suffers from certain shortcomings. Each DRAM memory cell must be periodically refreshed in order to avoid data loss. While necessary, refresh operations require time and energy, and the data in a memory cell cannot be accessed while the refresh operation is occurring.

It has been observed that at higher temperatures, the charge decay in a DRAM memory cell occurs more quickly. Therefore, a cell that is at a higher temperature must be refreshed more often in order to maintain memory integrity. In some SiPs (e.g., the SiP device 100), the HBM device 130 provides information to the host device 120 indicating that a higher refresh rate may be advantageous in order to reduce the possibility of memory loss. For example, the HBM device 130 may communicate to the host device 120 (e.g., over dedicated lines of the communication channel 150) an indication that a refresh rate of double or quadruple a base refresh rate is advantageous due to temperature of the HBM device 130. In response, the host device 120 will issue refresh commands at an increased rate.

However, the above-described approach suffers from certain shortcomings. For instance, the HBM device 130 may only use the highest temperature of all devices in the HBM device 130 to determine the necessary refresh rate that it communicates to the host device 120. Further, the host device 120 does not have available to it more localized temperature data of the HBM device 130. Thus, the host device 120 cannot selectively increase the refresh rate on memory regions associated with a hotter memory array, and instead must increase the refresh rate on all memory arrays in response to the singular indication from the HBM device 130. This setup is insensitive to the fact that some memory arrays may have a higher temperature than others, and that not all memory arrays may need a higher refresh rate. Thus, time and energy are wasted in issuing unnecessary refresh operations to arrays that are not hot enough to warrant a higher refresh rate.

HBM devices with localized refresh adjustment, and related system and methods that address the shortcomings discussed above, are disclosed herein. As discussed in more detail below, an HBM device with localized refresh adjustment can include multiple temperature sensors, each associated with a memory region of the device, that characterize the temperature of a memory array associated with the memory region. When the device receives a refresh command (e.g., from a host device) that identifies a memory region (e.g., the refresh command specifies the memory region, a memory address within the memory region, etc., to be refreshed), the HBM device with localized refresh adjustment compares the temperature of the memory array, associated with that memory region, with one or more threshold values. Based on the temperature comparison, the HBM device performs one or more refresh operations on the memory array in response to the refresh command. For example, if the temperature does not exceed a first threshold the HBM device may perform one refresh operation, if the temperature exceeds a first threshold the HBM device may perform two refresh operations, if the temperature exceeds a second threshold the HBM device may perform three refresh operations, and so on. Further, the HBM device with localized refresh adjustment uses temperature data associated with the particular memory region specified by each host refresh command, and generates one or more refresh operations accordingly, independent of the temperature of other memory regions. Therefore, the number of refresh operations performed can be different for each memory array, leading to an independent refresh rate for each memory array. Accordingly, if the device receives a refresh command that identifies multiple memory regions, the device can consider the temperature of each associated memory array and perform refresh operations on the memory arrays in accordance with the temperatures of each memory array independently.

Additionally, in some embodiments the HBM device with localized refresh adjustment may generate its own refresh commands (for example, in addition to and/or in lieu of refresh commands from a host device). In some embodiments, the HBM device regularly chooses a refresh memory region to issue one or more refresh commands to. The device first compares the temperature of the memory array associated with the memory region to one or more threshold values. Subject to the temperature comparison, the device issues to itself one or more refresh commands identifying the memory region, each of which results in performing one refresh operation on the associated memory array. In some embodiments in which the HBM device generates its own refresh commands, the host device may continue to issue refresh commands to the HBM device.

The systems and methods described herein help make the refresh process more efficient by allowing hotter regions of the HBM DRAM dies to have a higher refresh rate while allowing other regions to have a lower refresh rate.

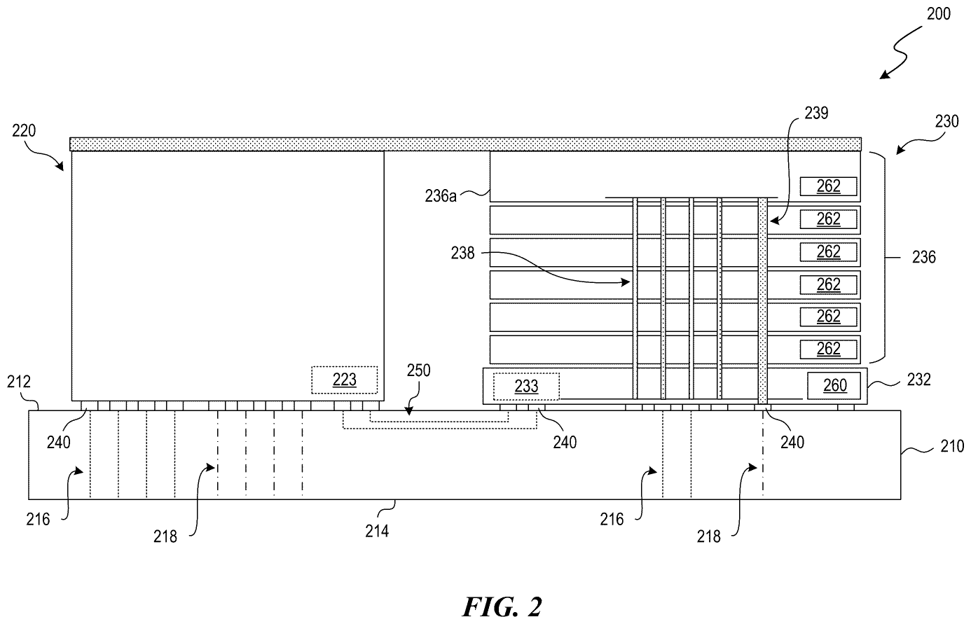

Additional details on HBM devices with localized refresh adjustment, components therefore, and related systems and methods are discussed below with reference to FIGS. 2-5.

### HBM Device With Localized Refresh Adjustment

FIG. 2 is a partially schematic cross-sectional diagram of a SiP device 200 configured in accordance with some embodiments of the present technology. In FIG. 2, elements labeled with reference numerals in the 2xx series (e.g., 200, 210, 230, etc.) correspond to and are substantially similar in structure and function to their counterparts in FIG. 1 labeled with reference numerals in the 1xx series (e.g., 100, 110, 130, etc.), respectively, unless explicitly described otherwise herein.

As illustrated in FIG. 2, the SiP device 200 can include a base substrate 210, as well as HBM device with localized refresh adjustment 230 (“HBM device 230”) and host device 220 for use with the HBM device with localized refresh adjustment 230, each integrated with (e.g., carried by and coupled to) an upper surface 212 of the base substrate 210 by interconnect structures 240. As described in greater detail below, the HBM device with localized refresh adjustment 230 includes a refresh management circuit 260 in an interface die 232, and also includes one or more temperature sensors 262 in each of the memory dies 236. The base substrate 210 can include one or more external signal TSVs 216 (four illustrated in FIG. 2) and one or more external power TSVs 218 extending between the upper surface 212 (sometimes also referred to herein as an “active surface”) and a lower surface 214 of the base substrate 210. The external signal TSVs 216, via the interconnect structures 240, allow the host device 220 and the HBM device with localized refresh adjustment 230 to receive signals from (and send signals to) another component coupled to the lower surface 214 of the base substrate 210 (e.g., from another controller coupled to a PCB the SiP device 200 is coupled to and/or the like). Similarly, the external power TSVs 218, via the interconnect structures 240, allow the host device 220 and the HBM device with localized refresh adjustment 230 to receive power from another component coupled to the lower surface 214 of the base substrate 210 (e.g., from the PCB the SiP device 200 is coupled to and/or the like).

As further illustrated in FIG. 2, the base substrate 210 includes a plurality of external signal TSVs 216 and a plurality of external power TSVs 218 extending between the upper surface 212 and a lower surface 214 of the base substrate 210. The external signal TSVs 216 can communicate signals (e.g., data, control signals, processing commands, and/or the like) between the host device 220 and/or the HBM device with localized refresh adjustment 230 and an external component (e.g., a PCB the base substrate 210 is integrated with, an external controller, and/or the like). The external power TSVs 218 provide electrical power to the host device 220 and/or the HBM device with localized refresh adjustment 230 from an external power source.

The host device 220 can include a variety of components, such as a processing unit (e.g., CPU/GPU/TCU), one or more registers, one or more cache memories, and/or a variety of other components. For example, in the illustrated environment, the host device 220 includes a host IO circuit 223 that can direct signals to and/or from the HBM device with localized refresh adjustment 230 through the communication channels 250. Additionally, or alternatively, the host IO circuit 223 can direct signals to and/or from an external component (e.g., a controller coupled to one or more of the external signal TSVs 216 and/or the like).

The HBM device with localized refresh adjustment 230 can include an interface die 232 and a stack of one or more memory dies 236 (six illustrated in FIG. 2) carried by the interface die 232. As illustrated in FIG. 2, the interface die 232 includes a refresh management circuit 260, and each of the memory dies 236 includes a temperature sensor 262. Although FIG. 2 illustrates an embodiment of the HBM device 230 in which each memory die 236 includes one temperature sensor 262, it will be appreciated that in some embodiments of the HBM device 230 there may be a plurality of temperature sensors 262 included in each memory die 236, where each of the temperature sensors 262 are positioned at different locations of the corresponding memory die 236 and associated with a different component of the memory die 236 therein. For example, a memory die 236 may be composed of multiple physical memory arrays, each memory array being associated with one or more logical memory regions, and each memory region being associated with a temperature sensor 262. Each temperature sensor 262 characterizes the temperature of the memory array associated with a memory region, and provides temperature data (e.g., over signal TSVs 238 or other interconnect of the HBM device 230) to the refresh management circuit 260. The HBM device 230 (and the refresh management circuit 260 therein) receives refresh commands from the host device 220 (e.g., over the communication channels 250). Each refresh command from the host device 220 may identify one or more memory regions of the HBM device 230 for which the host device 220 requests a refresh. For example, a refresh command from the host device 220 may identify a bank, a bank group, or all banks, to be refreshed in response to the refresh command. In some embodiments, the host device 220 includes an integrated memory controller circuit (not shown) that manages the flow of data to and from the HBM device 230 and additionally manages the issuance of refresh commands to the HBM device 230.

As described above, each of the one or more temperature sensors 262 of the memory dies 236 provide temperature data associated with a memory region (characterizing the temperature of an associated memory array) to the refresh management circuit 260. When the HBM device with localized refresh adjustment 230 receives a refresh command that specifies one or more memory regions of the HBM device 230 (e.g., a bank or bank group in a particular memory die 236 and/or all banks), the refresh management circuit 260 identifies the temperature data from the temperature sensors 262 associated with each of the specified memory regions. That is, for example, if the refresh command specifies a bank the refresh management circuit 260 may identify temperature data of the temperature sensor 262 associated with that bank, if the refresh command specifies a bank group the refresh management circuit 260 may identify temperature data of one or more temperature sensors 262 associated with the bank group, etc. The identified temperature data characterizes the temperature of the memory array associated with the memory region specified by the refresh command. If the temperature of the memory array is high enough that an increased refresh rate is advantageous in order to reduce the possibly of memory loss, then the refresh management circuit 260 issues multiple refresh operations to the memory region, thus performing multiple refresh operations on the associated memory array, in accordance with the increased refresh rate. In some embodiments, the refresh management circuit 260 compares the identified temperature data to a threshold value, and issues multiple refresh operations to the memory array if the temperature of the memory array is above a threshold temperature. The threshold temperature may, for example, be specified via a configuration register, a fuse, a hardcoded value, etc. Each refresh operation may include reading data, from the memory array, at a memory location within the associated memory region and writing the data back to the memory array at a memory location within the associated memory array. In some embodiments, each memory array contains multiple memory rows, and each refresh operation is performed on a single memory row (e.g., the data of a memory location consisting of a single row is read and written to the memory array), multiple memory rows, etc. The HBM device with localized refresh adjustment 230 may include a row counter circuit that is incremented when a refresh operation is performed on the memory array, where the value stored in the row counter circuit determines the memory row that the refresh operation is performed on. In such an embodiment, sequential refresh operations issued to the same memory region, associated with the memory array, will act on different memory rows of the memory array (e.g., the next memory row indicated by the row counter circuit).

Certain refresh commands received by the HBM device with localized refresh adjustment 230 may identify multiple regions. If multiple regions are identified by the refresh command, the refresh management circuit 260 may perform refresh operations on each memory array based on the temperature data from a single temperature sensor (such as by taking the highest temperature data of the temperature sensors associated with the memory regions). Alternately, the refresh management circuit 260 may perform an independent number of refresh operations on each memory array based on the temperature of that memory array. The refresh management circuit 260 may combine the two approaches by, for example, performing refresh operations on a plurality of memory arrays based on the temperature data of a single temperature sensor associated with one of the plurality of memory regions, but perform refresh operations independently on another one or more memory arrays.

In some embodiments, the HBM device with localized refresh adjustment 230 will request a higher rate of refresh commands from the host device 220. For example, there may be dedicated communication channels 250 to signal to the host device 220 that a higher rate of refresh commands is expected from the host device 220. If so, the refresh management circuit 260 may still perform multiple refresh operations in response to a refresh command, in accordance with the present disclosure. In some embodiments, the refresh management circuit 260 does not compare temperature data to a threshold value unless the HBM device 230 is signaling to the host device 220 that a higher rate of refresh commands is expected. In some embodiments, when the refresh management circuit 260 compares temperature data from a temperature sensor to a threshold value, the threshold value will be different depending on whether the HBM device with localized refresh adjustment 230 is signaling to the host device 220 that a higher rate of refresh commands is expected. For example, an HBM device 230 uses a first threshold value that specifies a temperature at which it is advantageous to refresh a memory array at twice a base refresh rate. If the HBM device 230 receives a refresh command from the host device 220 that identifies a memory region with associated temperature data exceeding this first threshold, then the HBM device 230 performs two refresh operations on the associated memory array, and if the first threshold is not exceeded, it performs one refresh operation. However, if the HBM device 230 is signaling to the host device 220 that refresh commands are expected at double the base refresh rate, the HBM device 230 may instead use a second threshold value that specifies a temperature at which it is advantageous to refresh a memory array at four times the base refresh rate. If the HBM device 230 then receives a refresh command from the host device 220 that identifies a memory region with associated temperature data exceeding this second threshold, then the HBM device 230 performs two refresh operations on the associated memory array, since refresh commands are expected to be sent from the host device 220 at double the base rate, and if the second threshold is not exceeded, it performs one refresh operation.

In some embodiments, the HBM device with localized refresh adjustment 230 conforms to a JEDEC HBM DRAM standard (e.g., HBM2, HBM3, HBM3E, etc.). For example, the JEDEC HBM DRAM standard requires a minimum time t_{RFCpb} between an all-bank refresh command (REFab) and any subsequent all-bank refresh or access command, and additionally requires a minimum time t_{RFCpb} between a per-bank refresh command (REFpb) and any subsequent per-bank refresh or access command directed to the same bank. In some embodiments, the temperature sensors 262 of the HBM device 230 are each associated with a bank of the one or more memory dies 236 (e.g., a memory region corresponds to a bank). In this case, REFpb is a refresh command that identifies a particular region in accordance with the present disclosure, and REFab is a refresh command that identifies all regions. When a REFab or REFpb command is issued by a host device, the HBM device 230 may perform multiple refresh operations within the minimum time guaranteed by the JEDEC HBM DRAM standard. The refresh management circuit 260 can utilize this to perform multiple refresh operations on the array, within the required minimum time, in response to receiving such a refresh command, allowing an HBM device with localized refresh adjustment 230 to conform to the JEDEC HBM DRAM standard.

In some embodiments, the HBM device with localized refresh adjustment 230 is configured to generate refresh commands and/or refresh operations that are issued to itself or directly to the memory regions of the memory dies 236 (e.g., without requiring refresh commands from a host device or in addition to refresh commands from a host device). For example, the refresh management circuit 260 may be configured to monitor the temperature data from temperature sensors 262 associated with memory regions on the memory dies 236. Based on the monitored temperature data, the refresh management circuit 260 may issue refresh commands (such that the memory arrays receive refresh operations at the rate suggested by their temperatures) even if no refresh command is received from a host device.

The HBM device with localized refresh adjustment 230 also includes one or more signal TSVs 238 (four illustrated in FIG. 2) and one or more power TSVs 239 (one illustrated in FIG. 2) each extending from the interface die 232 to an uppermost memory die 236a. The power TSV(s) 239 provide power (e.g., received from one or more of the external power TSVs 218) to the interface die 232 and each of the memory dies 236. The signal TSVs 238 communicably couple each of the memory dies 236 to an IO circuit 233 in the interface die 232 (in addition to various other circuits in the interface die 232, possibly including the refresh management circuit 260). In turn, the IO circuit 233 can direct signals to and/or from the host device 220 and/or an external component (e.g., an external storage device coupled to one or more of the external signal TSVs 216).

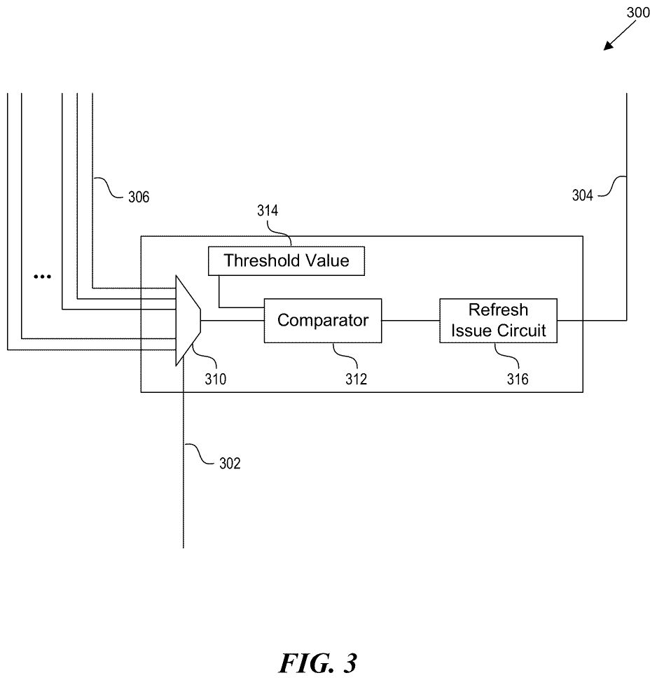

FIG. 3 is a block diagram schematically illustrating a refresh management circuit 300 configured in accordance with some embodiments of the present technology. The refresh management circuit 300 can receive refresh commands 302 and issue refresh operations 304. The refresh management circuit 300 receives multiple temperature values 306 each associated with a temperature sensor associated with a memory region of a memory die (e.g., temperature sensors 262 of one or more memory dies 236 illustrated in FIG. 2).

In some embodiments, the refresh management circuit 300 activates when receiving a refresh command 302 that identifies a memory region of a memory die. This refresh command may, for example, originate from a host device (e.g., host device 220 illustrated in FIG. 2) or a circuit internal to the HBM device with localized refresh adjustment. The refresh command may identify additional memory regions of the memory die or of other memory dies. Upon receiving the refresh command 302, the refresh management circuit 300 selects (e.g., using a multiplexor 310) the temperature value 306 provided by the temperature sensor associated with the identified memory region. For example, the refresh management circuit 300 and/or multiplexor 310 may decode the received refresh command, identify the one or more memory regions specified by the refresh command, and select the corresponding temperature value 306 accordingly. The temperature value 306 associated with the identified region is then provided to a comparator 312 that compares the temperature value with a threshold value 314. The result of the comparison (e.g., an indication of whether the temperature value exceeds the threshold value 314) is provided to the refresh issue circuit 316, which issues two or more refresh operations 304 to the identified memory region if the temperature value 306 is greater than or equal to the threshold value 314, and issues one refresh operation 304 to the memory region if the temperature value 306 is less than the threshold value 314. Although one threshold value 314 is shown, some embodiments may have multiple possible threshold values. For example, the threshold value 314 used by the comparator 312 may depend on the expected rate at which refresh commands 302 are to be received. In some embodiments, the threshold value 314 used by the comparator 312 may be determined in part by whether the HBM device is signaling to a host device that a higher rate of refresh commands is expected.

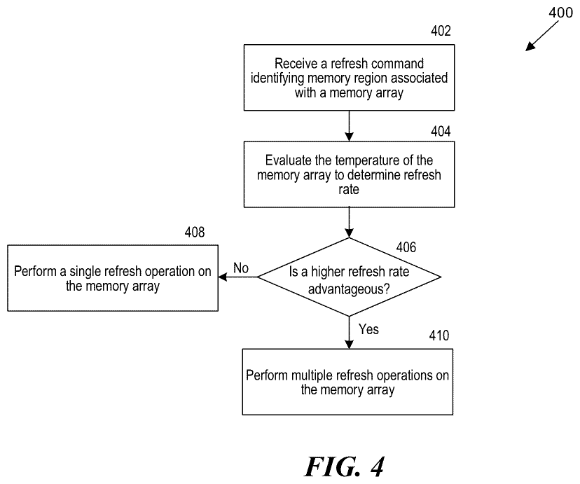

FIG. 4 is a flowchart 400 illustrating a method of performing one or more refresh operations on a memory array in an HBM device with localized refresh adjustment, in accordance with some embodiments of the present technology. The HBM device with localized refresh adjustment may include one or more volatile memory dies, one or more temperature sensors, and may include an interface die. A memory die is composed of memory arrays, which are each associated with a memory region. A memory region may be associated with a temperature sensor, which generates temperature data characterizing the temperature of the memory array that the memory region is associated with.

At block 402, the HBM device with localized refresh adjustment receives a refresh command that identifies a refresh memory region that is associated with a memory array. The refresh memory region may be associated with one or more banks of a memory array. The refresh command may be a command issued by a host device, may include address information that identifies the refresh memory region, and may be a refresh command that identifies additional memory regions. The refresh command may be a command conforming to a standard, such as a per-bank refresh command REFpb or an all-bank refresh command REFab.

At block 404, the temperature data characterizing the temperature of a memory array associated with the refresh memory region is evaluated to determine if a higher refresh rate for the memory array would be advantageous in order to reduce the possibility of memory loss. The temperature data is generated by a temperature sensor associated with the refresh memory region. Block 404 can be accomplished by, for example, comparing the value of the temperature data with a threshold value that determines the temperature above which more frequent memory refreshes may be advantageous in order to reduce the possibility of memory loss. In some implementations, there may be multiple threshold values, each associated with a different refresh rate. In some implementations, the chosen threshold value may depend on other factors, such as whether the HBM device with localized refresh adjustment is issuing a signal to a host device requesting a higher rate of refresh commands. Alternately, the temperature of the memory array may be compared to a threshold temperature only if the HBM device with localized refresh adjustment is indicating to the host device a request for a higher rate of refresh commands.

At block 406, the result of the comparison in block 404 is used to determine the number of refresh operations to be performed on the memory array associated with the refresh memory region. If the temperature is not above the threshold value, then at block 408 a single refresh operation is performed on the memory array. If the temperature is above the threshold value, then at block 410 multiple refresh operations are performed on the memory array. For example, two or four refresh operations may be issued to the refresh memory region and thus performed on the memory array. Each refresh operation may involve reading data from the memory array at a memory location within the refresh memory region, such as data corresponding to a memory row, and then writing the data to the memory location within the memory region.

Furthermore, the HBM device with local refresh adjustment may perform refresh operations on memory arrays independently based on the individual temperatures of each memory array. In some implementations, the HBM device receives a first refresh command from a host device communicably coupled to the HBM device, where the first refresh command is associated with a first memory region. The HBM device identifies first temperature data, generated by a first temperature sensor, associated with the first memory region, and determines whether the first temperature data exceeds a threshold temperature. If so, the HBM device performs a first number of refresh operations on a first memory array associated with the first memory region, based on determining whether the first temperature data exceeds the threshold temperature. The HBM device then receives, from the host device, a second refresh command associated with a second memory region. The HBM device identifies second temperature data, generated by a second temperature sensor, associated with the second memory region, and determines whether the second temperature data exceeds the threshold temperature. If so, the HBM device performs a second number of refresh operations on a second memory array associated with the second memory region, based on determining whether the second temperature data exceeds the threshold temperature. The first and second number of refresh operations may be different.

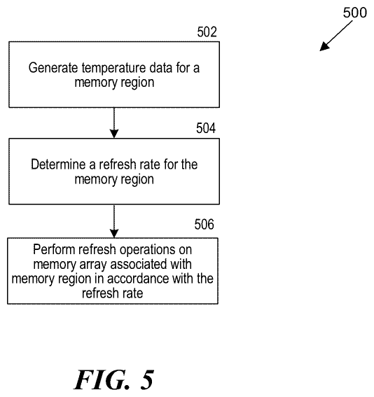

FIG. 5 is a flowchart 500 illustrating a method of refreshing a memory array in an HBM device with localized refresh adjustment, in accordance with some embodiments of the present technology. The HBM device with localized refresh adjustment may include one or more volatile memory dies, one or more temperature sensors, and may include an interface die. A memory die is composed of memory arrays, which are each associated with a memory region. A memory region may be associated with a temperature sensor, which generates temperature data characterizing the temperature of the memory array that the memory region is associated with.

At block 502, the HBM device with localized refresh adjustment generates temperature data associated with a memory region.

At block 504, a refresh rate for the memory region is determined. For example, the temperature data may be compared with a threshold value, which determines the threshold temperature above which more frequent memory refreshes may be advantageous in order to reduce the possibility of memory loss. This may lead to the refresh rate being a base refresh rate if the temperature is not above the threshold temperature, or a rate higher than the base refresh rate if the temperature is above the threshold temperature. This higher rate may be some multiple of the base rate, such as double or quadruple the base refresh rate. In some implementations, the chosen refresh rate may depend on other factors, such as whether the HBM device with localized refresh adjustment is issuing a signal to the host device requesting a higher rate of refresh commands.

At block 506, refresh operations are performed on the memory array associated with the memory region in accordance with the refresh rate. For example, the time between two refresh operations may be based in part on the refresh rate. In some implementations, the HBM device with localized refresh adjustment may receive a refresh command from a host device that identifies a memory region. The HBM device with localized refresh adjustment may then perform refresh operations in accordance with both the refresh rate and the received refresh command. For example, a first refresh operation may be performed on a memory array associated with the refresh memory region identified by the received refresh command, and then a second refresh operation may be performed after an amount of time that is determined by the determined refresh rate of the memory region. This received refresh command may be a command that identifies a single memory region (e.g., a per-bank refresh command such as REFpb) or may be a refresh command that identifies multiple memory regions (e.g., an all-bank refresh command such as REFab). The command may include address information that identifies the memory region. Furthermore, the HBM device may perform refresh operations on memory arrays independently based on the individual temperatures of each memory array. In some implementations, the HBM device will determine, based in part on temperature data generated by a second temperature sensor associated with a second memory region, a refresh rate for the second memory region, and perform refresh operations on a second memory array associated with the second memory region, where a time between the refresh operations is based in part on the determined refresh rate of the second memory region.

### Conclusion

From the foregoing, it will be appreciated that specific embodiments of the technology have been described herein for purposes of illustration, but well-known structures and functions have not been shown or described in detail to avoid unnecessarily obscuring the description of the embodiments of the technology. To the extent any material incorporated herein by reference conflicts with the present disclosure, the present disclosure controls. Where the context permits, singular or plural terms may also include the plural or singular term, respectively. Moreover, unless the word “or” is expressly limited to mean only a single item exclusive from the other items in reference to a list of two or more items, then the use of “or” in such a list is to be interpreted as including (a) any single item in the list, (b) all of the items in the list, or (c) any combination of the items in the list. Furthermore, as used herein, the phrase “and/or” as in “A and/or B” refers to A alone, B alone, and both A and B. Additionally, the terms “comprising,” “including,” “having,” and “with” are used throughout to mean including at least the recited feature(s) such that any greater number of the same features and/or additional types of other features are not precluded. Further, the terms “approximately,” “generally,” and/or “about” are used herein to mean within at least 10% of a given value or limit. Purely by way of example, an approximate ratio means within 10% of the given ratio.

Several implementations of the disclosed technology are described above in reference to the figures. The computing devices on which the described technology may be implemented can include one or more central processing units, memory, input devices (e.g., keyboard and pointing devices), output devices (e.g., display devices), storage devices (e.g., disk drives), and network devices (e.g., network interfaces). The memory and storage devices are computer-readable storage media that can store instructions that implement at least portions of the described technology. In addition, the data structures and message structures can be stored or transmitted via a data transmission medium, such as a signal on a communications link. Various communications links can be used, such as the Internet, a local area network, a wide area network, or a point-to-point dial-up connection. Thus, computer-readable media can comprise computer-readable storage media (e.g., “non-transitory” media) and computer-readable transmission media.

From the foregoing, it will also be appreciated that various modifications may be made without deviating from the disclosure or the technology. For example, one of ordinary skill in the art will understand that various components of the technology can be further divided into subcomponents, or that various components and functions of the technology may be combined and integrated. In addition, certain aspects of the technology described in the context of particular embodiments may also be combined or eliminated in other embodiments.

Furthermore, although advantages associated with certain embodiments of the technology have been described in the context of those embodiments, other embodiments may also exhibit such advantages, and not all embodiments need necessarily exhibit such advantages to fall within the scope of the technology. Accordingly, the disclosure and associated technology can encompass other embodiments not expressly shown or described herein.

I/We claim:

1. A high-bandwidth memory (HBM) device, comprising:
one or more volatile memory dies, each memory die comprising one or more memory arrays, where each memory array is associated with one or more memory regions;
one or more temperature sensors, wherein each temperature sensor is associated with a memory region and configured to generate temperature data characterizing a temperature of a memory array associated with the memory region; and
an interface die carrying the one or more volatile memory dies, wherein the interface die comprises a refresh management circuit, the refresh management circuit configured to:
receive, from a host device, a refresh command, wherein the refresh command identifies a refresh memory region;
evaluate temperature data characterizing the temperature of a memory array associated with the refresh memory region to determine whether the memory array associated with the refresh memory region is above a threshold temperature; and
perform, in response to determining that the memory array associated with the refresh memory region is above a threshold temperature, two or more refresh operations on the memory array associated with the refresh memory region.

2. The HBM device of claim 1, wherein the refresh management circuit is further configured to:
perform, in response to determining that the memory array associated with the refresh memory region is not above the threshold temperature, one refresh operation on the memory array associated with the refresh memory region.

3. The HBM device of claim 1, wherein the refresh management circuit is further configured to:
evaluate temperature data characterizing the temperature of a memory array associated with the refresh memory region to determine whether the memory array associated with the refresh memory region is above a second threshold temperature; and
perform, in response to determining that the memory array associated with the refresh memory region is above a second threshold temperature, three or more refresh operations on the memory array associated with the refresh memory region.

4. The HBM device of claim 1, wherein the refresh command comprises address information, and wherein the refresh memory region is identified based on the address information.

5. The HBM device of claim 1, wherein the refresh command is an all-bank refresh command (REFab) or a per-bank refresh command (REFpb).

6. The HBM device of claim 1, wherein a memory region is associated with one or more banks of a memory array.

7. The HBM device of claim 1, wherein a refresh operation comprises:
reading data, from the memory array, at a memory location within the refresh memory region; and
writing the data, to the memory array, at the memory location within the refresh memory region.

8. The HBM device of claim 1, wherein the refresh management circuit is further configured to:
determine that the HBM device has indicated to the host device a request for a higher rate of refresh commands; and
perform, at least in part in response to the determination, one or more refresh operations on a memory array associated with a refresh memory region.

9. The HBM device of claim 1, wherein refresh management circuit is further configured to:
receive a refresh command that identifies more than one refresh memory region;
evaluate temperature data characterizing the temperature of memory arrays associated with the refresh memory regions to determine whether a memory array associated with a refresh memory region is above a threshold temperature; and
perform, in response to determining that a memory array associated with a refresh memory region is above a threshold temperature, two or more refresh operations on each memory array associated with the refresh memory regions.

10. A high-bandwidth memory (HBM) device, comprising:
one or more volatile memory dies, each memory die comprising one or more memory arrays, where each memory array is associated with one or more memory regions;
one or more temperature sensors, wherein each temperature sensor is associated with a memory region and configured to generate temperature data characterizing a temperature of a memory array associated with the memory region; and
an interface die carrying the one or more volatile memory dies, wherein the interface die comprises a refresh management circuit, the refresh management circuit configured to:
determine, based in part on temperature data generated by a temperature sensor associated with a memory region, a refresh rate for the memory region; and
perform refresh operations on a memory array associated with the memory region,
wherein a time between the refresh operations is based in part on the determined refresh rate of the memory region.

11. The HBM device of claim 10, wherein determining a refresh rate for a memory region comprises:
comparing the temperature of a memory array associated with the memory region to a threshold temperature;
determining, in response to the temperature not being above the threshold temperature, that the refresh rate for the memory region will be a base refresh rate; and
determining, in response to the temperature being above the threshold temperature, that the refresh rate for the memory region will be higher than the base refresh rate.

12. The HBM device of claim 11, wherein determining that the refresh rate for the memory region will be higher than the base refresh rate further comprises:
determining that the refresh rate will be double or quadruple the base refresh rate.

13. The HBM device of claim 10, wherein the refresh management circuit is further configured to:
receive, from a host device, a refresh command, wherein the refresh command identifies the memory region;
perform a first refresh operation on the memory array associated with the memory region in accordance with the refresh command; and
perform a second refresh operation on the memory array associated with the memory region,
wherein a time between the first refresh operation and the second refresh operation is based in part on the determined refresh rate of the memory region.

14. The HBM device of claim 13, wherein the refresh command is an all-bank refresh command (REFab) or a per-bank refresh command (REFpb).

15. The HBM device of claim 10, wherein a memory region is associated with one or more banks of a memory array.

16. The HBM device of claim 10, wherein the refresh management circuit is further configured to:
determine, based in part on temperature data generated by a second temperature sensor associated with a second memory region, a refresh rate for the second memory region; and
perform refresh operations on a second memory array associated with the second memory region,
wherein a time between the refresh operations is based in part on the determined refresh rate of the second memory region.

17. The HBM device of claim 10, wherein a refresh operation comprises:
reading data, from the memory array, at a memory location within the refresh memory region; and
writing the data, to the memory array, at the memory location within the refresh memory region.

18. A method for refreshing a high-bandwidth memory (HBM) device, the method comprising:
receiving, at a high-bandwidth memory (HBM) device, a first refresh command from a host device communicably coupled to the HBM device, wherein the first refresh command is associated with a first memory region;
identifying first temperature data, generated by a first temperature sensor, associated with the first memory region;
determining whether the first temperature data exceeds a threshold temperature;
performing a first number of refresh operations on a first memory array associated with the first memory region, wherein the first number of refresh operations is based on determining whether the first temperature data exceeds the threshold temperature;
receiving, at the HBM device, a second refresh command from the host device communicably coupled to the HBM device, wherein the second refresh command is associated with a second memory region;
identifying second temperature data, generated by a second temperature sensor, associated with the second memory region;
determining whether the second temperature data exceeds the threshold temperature; and
performing a second number of refresh operations on a second memory array associated with the second memory region, wherein the second number of refresh operations is based on determining whether the second temperature data exceeds the threshold temperature.

19. The method of claim 18, wherein the first number of refresh operations differs from the second number of refresh operations.

20. The method of claim 18, wherein performing a refresh operation on a memory array comprises:
reading data, from the memory array, at a memory location within an associated memory region; and
writing the data, to the memory array, at the memory location within the associated memory region.
